(19) United States
(12) Patent Application Publication
(10) Pub. No.: US 2008/0278023 A1
(43) Pub. Date: Nov. 13, 2008

(54) BRUSHLESS MOTOR AND MANUFACTURING METHOD THEREFOR

(76) Inventor: Yasuhiro YAMAGATA, Chiba (JP)

Correspondence Address: MCGLEW AND TUTTLE, P.C., SCARBOROUGH STATION, SCARBOROUGH, NY, 10510-9227, US

(21) Appl. No.: 11/857,567

(22) Filed: Sep. 19, 2007

(30) Foreign Application Priority Data
Oct. 4, 2006 (JP) 2006-272634

(51) Int. Cl. H02K 3/46; H02K 15/08

(52) U.S. Cl. 310/198; 29/596

(57) ABSTRACT

Winding is wound around each of a plurality of core arm portions formed integrally with a core cylinder portion of a stator core. Windings wound around the respective core arm portions are 3-phase-configured such that one end of winding of each phase extends outwardly as an output wire, three output wires in total, and such that the other end of winding of each phase is connected at a common node, thereby establishing Y-connection. Two of the three output wires are fixedly pressed by crossover wires extending between windings wound around the respective core arm portions, whereas the remaining one output wire is fixedly pressed by a winding end wire of winding of an adjacent phase.

### BACKGROUND OF THE INVENTION

1. Field of the Invention

The present invention relates to a brushless motor and a manufacturing method therefor, and particularly to the configuration of windings wound around a plurality of core arm portions of a stator core.

2. Description of the Related Art

In formation of stator windings of a miniature motor, a wire starts to be wound from its winding start portion and is sequentially wound around a plurality of core arm portions of a stator core. After completion of winding, winding is apt to become loose from, particularly, a winding start portion of the wire. A loose winding start portion of the wire involves the risk of contact with a rotor. Since a retaining feature is not available for a wire on the winding start side or a wire on the winding end side, the wire fails to maintain its wound profile, potentially resulting in a loose wire overlying an existing winding. This means the addition of the thickness of a single wire, thus having an adverse effect on design for reduction in motor thickness. In such a case, additional man-hours for remedying winding arise.

FIGS. 8A to 8C exemplifies a winding method for avoiding the above-mentioned risk. FIG. 8A shows the start of winding on a core arm portion; FIG. 8B shows winding under way; and FIG. 8C shows the end of winding (refer to Japanese Utility Model Application Laid-Open (kokai) No. 59-78849. A core has a plurality of core arm portions provided circumferentially. FIGS. 8A to 8C show one of the core arm portions. This core arm portion has a shallow, slit-like recess formed on its end face. Winding is carried out as follows: as shown in FIG. 8A, a winding start portion of a wire is caught in the recess and extended along the core arm portion, and, as shown in FIG. 8B, a portion subsequent to the winding start portion of the wire is wound in an aligned manner around the core arm portion and on the extending winding start portion. As shown in FIG. 8C, after completion of winding, the extremity of a winding end portion of the wire and the extremity of the winding start portion of the wire are twisted together. Subsequently, each of the extremities is, for example, soldered to a printed circuit board.

However, the illustrated configuration involves the following drawbacks. The core must undergo special machining. Also, since winding overlies a wire on a winding start side, in a motor which must be designed to be thin, such as a motor for use in a DVD drive, the addition of the thickness of the single wire on the winding start side has an adverse effect on design for reduction in motor thickness.

As for other means for preventing loosening of a winding start/end portion of wire, after completion of winding, tape may be wound around the winding start/end portion, or the winding start/end portion may be completely covered with adhesive or the like. However, such post-winding work and associated parts are additionally required, resulting in an increase in cost.

### SUMMARY OF THE INVENTION

An object of the present invention is to solve the above-mentioned problems, and to prevent loosening of a winding start portion and a winding end portion of wire without having an adverse effect on design for reduction in motor thickness in a motor which must be designed to be thin, such as a motor for use in a DVD drive, thereby eliminating need of remedial work on winding which would otherwise arise from occurrence of a loose wire overlying an existing winding.

Another object of the present invention is to lower cost while occurrence of a loose wire overlying an existing winding is prevented without need to employ post-winding work, such as winding a winding start/end portion of wire with tape or completely covering the winding start/end portion with adhesive or the like after completion of winding, and associated parts and while workability of fixation on a board or the like is not impaired.

In a brushless motor and a manufacturing method therefor of the present invention, winding is wound around each of a plurality of core arm portions formed integrally with a core cylinder portion of a stator core. Windings wound around the respective core arm portions are 3-phase-configured such that one end of winding of each phase extends outwardly as an output wire, three output wires in total, and such that the other end of winding of each phase is connected at a common node, thereby establishing Y-connection. Two of the three output wires are fixedly pressed by crossover wires extending between windings wound around the respective core arm portions, whereas the remaining one output wire is fixedly pressed by a winding end wire of winding of an adjacent phase.

A single wire is continuously wound to form all of the windings, and, after completion of winding, wires extending between phases are cut away. The number of the core arm portions and the number of windings wound around the respective core arm portions are an integral multiple of 3.

According to the present invention, since all of the output wires are fixed when the output wires are about to be soldered, windings do not become loose. Thus, occurrence of a loose wire overlying an existing winding can be prevented without use of tape, adhesive, or the like.

According to the present invention, winding of a phase from which winding starts can be fixed without need of hooking in which a wire is wound several turns onto a core arm portion of an adjacent phase. Thus, all of the phases have the same winding inductance in terms of design, so that magnetic characteristics are not adversely effected.

### BRIEF DESCRIPTION OF THE DRAWINGS

FIG. 1 is a front sectional view showing a brushless motor according to an embodiment of the present invention;

FIG. 2 is a top view of a stator core and windings wound around the stator core shown in FIG. 1;

FIG. 3 is a diagram for explaining an electrical connection of a 3-phase brushless motor (DC brushless motor);

FIG. 4 is a diagram for explaining a procedure of winding on each of 12 core arm portions;

FIGS. 5A and 5B are views for explaining loosening of winding;

FIGS. 6A to 6C are views for explaining prevention of loosening of an output wire;

FIGS. 7A and 7B are views for explaining that an output wire is fixed independently of the direction of winding around a core arm portion; and

FIGS. 8A to 8C are views for explaining a conventional measure to prevent loosening of winding.

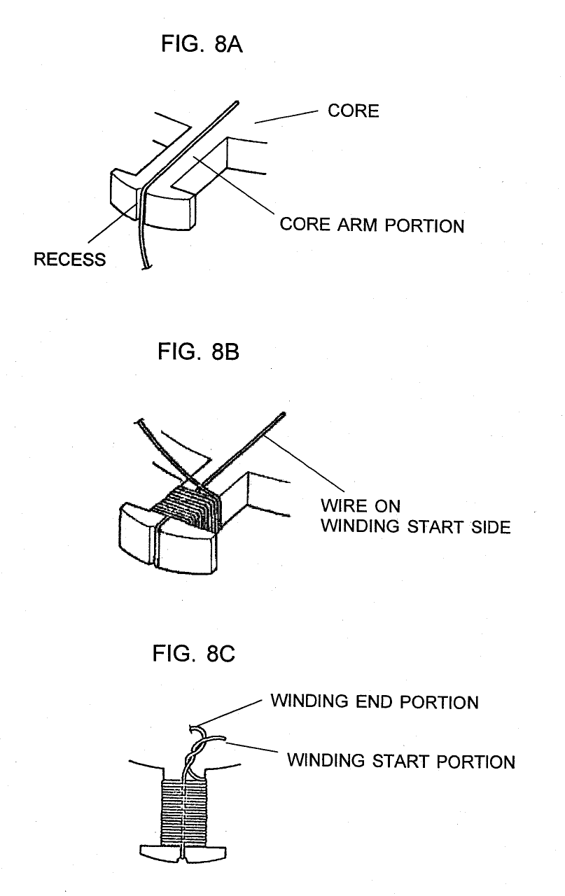

### DETAILED DESCRIPTION OF THE PREFERRED EMBODIMENTS

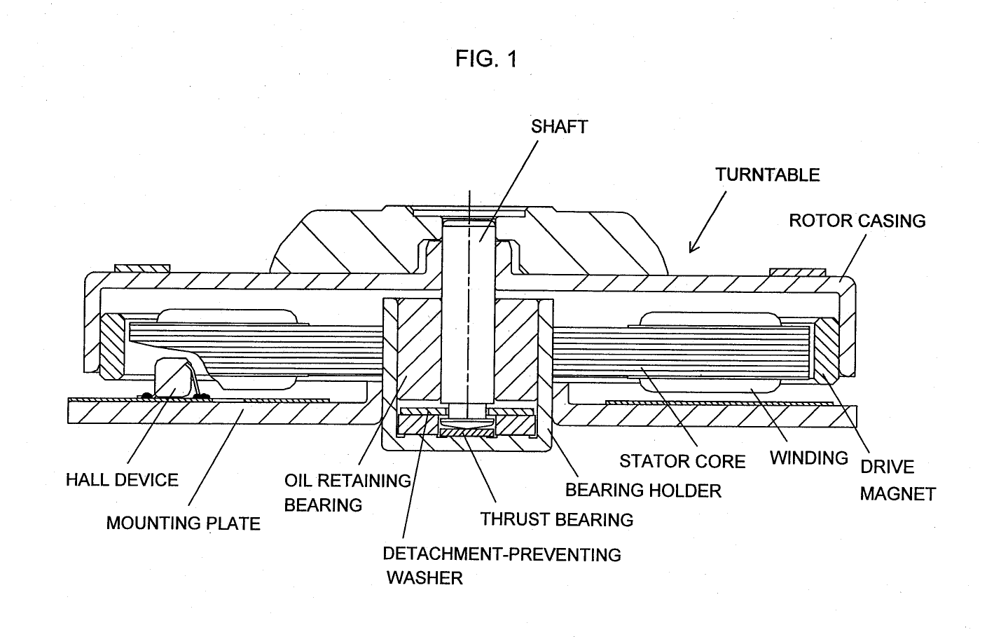

The present invention will next be described by way of examples. FIG. 1 is a front sectional view showing a brushless motor according to an embodiment of the present invention. The illustrated brushless motor is an outer-rotor-type brushless spindle motor having a cantilever bearing structure. A stator of the brushless motor is configured such that a laminated stator core around which windings are wound is attached to an outer circumference of a bearing holder attached to a mounting plate. The bearing holder contains an oilless bearing for a shaft and accommodates, at its central bottom portion, a thrust bearing for supporting an end portion of the shaft. A detachment-preventing washer is fitted into a groove of a small-diameter portion of the shaft and is latched by a bottom portion of the oilless bearing, thereby preventing detachment of the shaft. However, since the detachment-preventing washer is elastic, application of a strong force equal to or greater than a predetermined value allows axial insertion or detachment of the shaft.

A rotor of the brushless motor includes a rotor casing whose center is fixedly attached to the shaft, and a drive magnet attached to the rotor casing. The drive magnet assumes such a cylindrical shape as to face the laminated stator core from radially outside with a gap formed therebetween. The illustrated brushless motor is for application to a disc rotation drive apparatus and is configured such that the top surface of the rotor casing functions as a turn table which can carry an optical disc or the like.

The illustrated brushless motor has an electronic rectifier circuit. The electronic rectifier circuit detects a rotational angular position of the rotor by use of a Hall device or the like. On the basis of an associated detection signal, the electronic rectifier circuit controls current to be applied to each of a plurality of windings. The electronic rectifier circuit itself is well known.

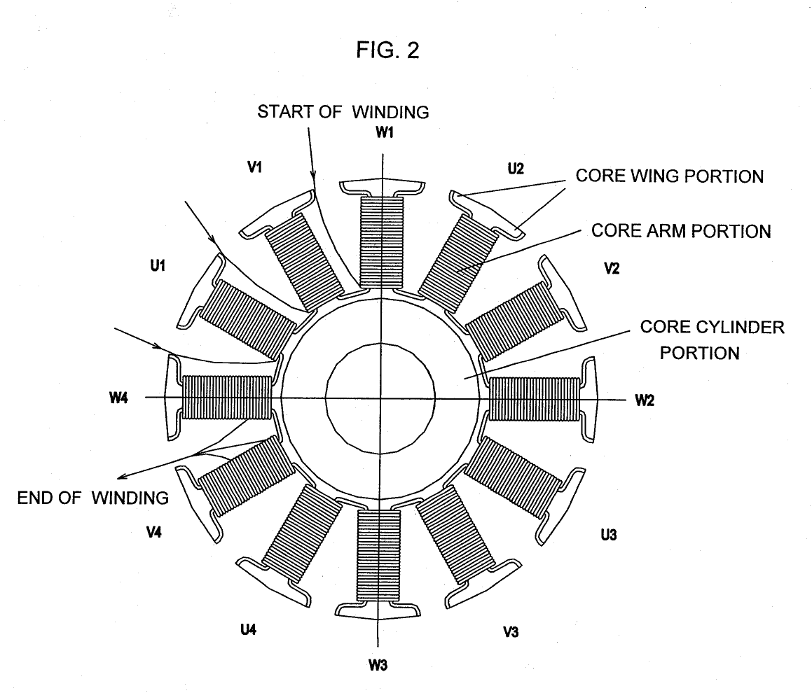

FIG. 2 is a top view of a stator core and windings wound around the stator core shown in FIG. 1. The illustrated stator core is constructed by laminating magnetic steel sheets such that 12 core arm portions are formed integrally with a core cylinder portion fixed to the outer circumference of the bearing holder and such that core wing portions project from the distal end of each core arm portion in opposite circumferential directions. The illustrated brushless motor is a so-called 3-phase brushless motor or DC brushless motor and has winding wound around each of the 12 (integral multiple of 3) arm portions. As illustrated, windings, as started from U1 and viewed clockwise, are U1, V1, W1, U2, V2, . . . , and W4. Four windings of each phase are connected in series, thereby forming winding of each of the U phase, V phase, and W phase of a Y-connection system. Windings of individual phases start from U1, V1, and W1, respectively; proceed in the numerical order; and end with U4, V4, and W4, respectively. However, in the following description, winding by use of a single, continuous wire starts from W1. As will be described later in detail, the present invention is characterized by windings wound around the core arm portions. The configuration itself of the brushless motor including the stator core can be a conventionally employed configuration.

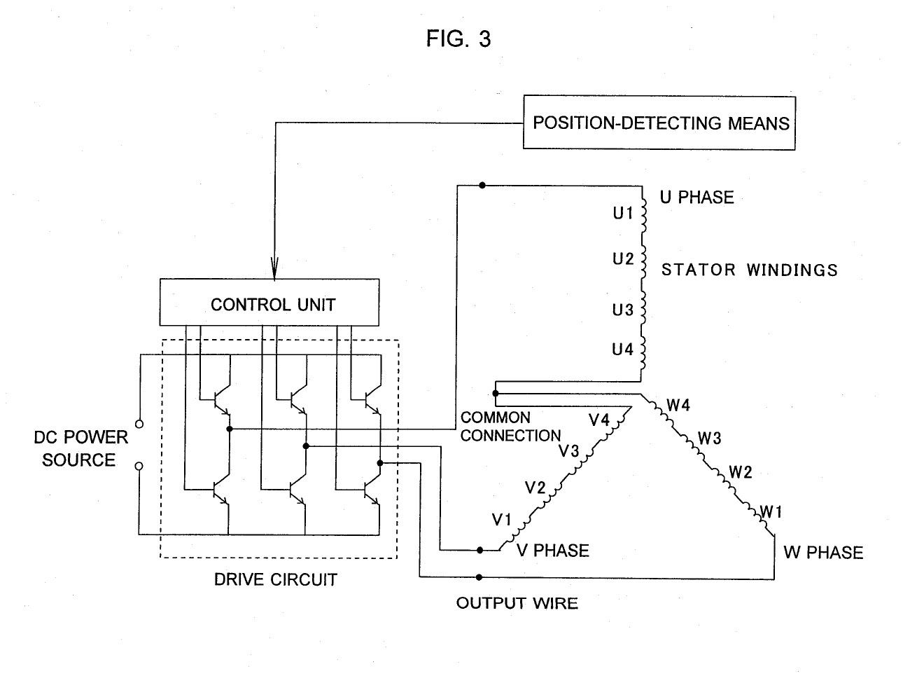

FIG. 3 is a diagram for explaining an electrical connection of the above-described 3-phase brushless motor (DC brushless motor). The electrical connection itself can be a conventionally employed connection. A total of 12 stator windings for three phases, 4 windings (integral multiple) each, are connected in a Y-connection system. In winding, which will be described later in detail, one end (output wire) of winding of each phase is connected to a drive circuit so as to be connected to a DC power source via the drive circuit as shown in FIG. 3, whereas the other end of winding of each phase is connected at a common node, thereby establishing Y-connection. The drive circuit itself can be an ordinary one. For example, as illustrated, the drive circuit can be composed of six switching transistors. A control unit for controlling switching of the switching transistors of the drive circuit can carry out control on the basis of a signal from a position-detecting means (Hall device) which detects a rotational position of the motor, as is well known.

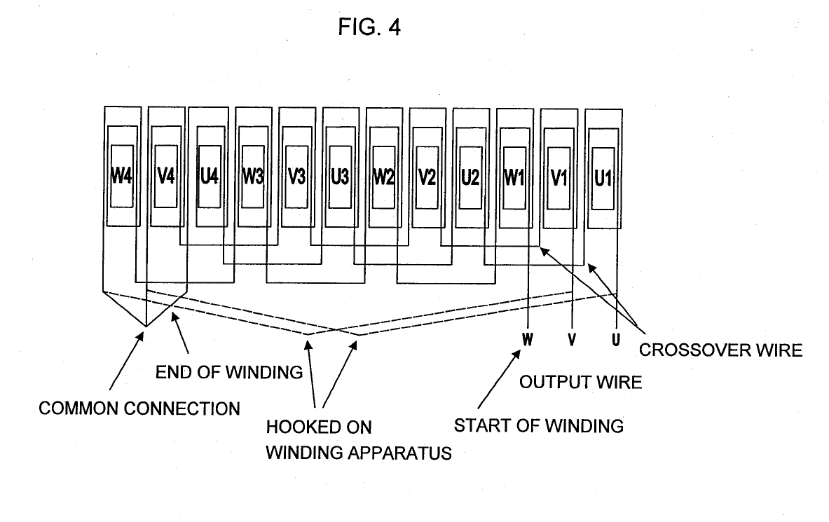

Next, winding around each of 12 core arm portions will be described with reference to FIG. 4. In view of work efficiency of winding, desirably, a single wire is continuously wound to form all of the windings, and wire segments to be cut away (wires extending between phases) are cut away after completion of winding. For continuous winding by use of a single insulated wire (e.g., polyester-coated copper wire or enameled wire), winding is started from, for example, W1 as shown in FIG. 4. After completion of winding of W1, winding of W2 starts. At this time, a wire extending between the core arm portions, such as a wire extending between a winding end wire of W1 and a winding start wire of W2, is illustrated as a crossover wire. As described with reference to FIG. 2, the 12 core arm portions are formed integrally with the core cylinder portion fixed to the outer circumference of the bearing holder, and the core wing portions are formed at the distal end of each of the core arm portions. In the following description, a side of the core arm portion toward the core cylinder portion is called the proximal side, and an opposite side of the core arm portion toward the core wing portions is called the distal side. In winding around each of the core arm portions, winding starts from the proximal side of the core arm portion and proceeds in an aligned manner toward the distal side of the core arm portion; subsequently, winding returns toward the proximal side of the core arm portion. Winding at each of the core arm portions ends at the proximal side of the core arm portion and proceeds to the proximal side of the adjacent core arm portion via a crossover wire. Similarly, after completion of winding of W2, winding proceeds to W3 via a crossover wire. After completion of winding of last W4 of the W phase, winding proceeds to V1 of the V phase. A wire extending between W4 and V1 is cut away after completion of all windings. However, in process of winding, the wire is not cut away, but is hooked on a portion of a winding apparatus for continuous winding to V1. In this manner, winding proceeds in the order of W1, W2, W3, W4, V1, V2, . . . , U3, and U4. When winding of U4 is completed, winding ends.

After completion of winding, a wire extending between the W phase and the V phase and a wire extending between the V phase and the U phase; i.e., a wire extending from W4 to V1 and a wire extending from V4 to U1 indicated by the respective dotted lines in FIG. 4, are cut away. The resultant winding end portions of W4 and V4 and a winding end portion of U4 are connected together, so that the winding end portions; i.e., common connection ends, do not become loose. Winding start end portions of W1 and V1 (output wires of the W phase and the V phase, respectively) are pressed by crossover wires, so that loosening is not initiated from the winding start end portions. However, since there is no crossover wire which presses a winding start end portion of U1 (output wire of the U phase), the winding start end portion of U1 will become loose if nothing is done.

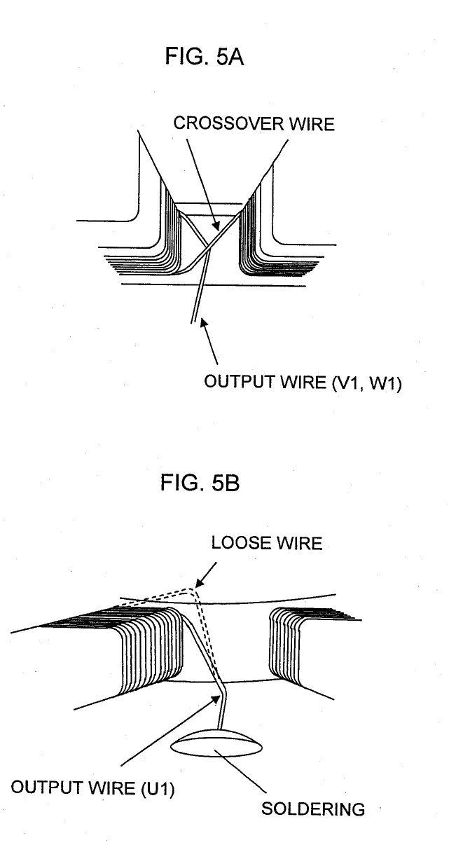

FIGS. 5A and 5B are views for explaining loosening of winding. FIG. 5A shows a state in which a winding start portion of an output wire (V1 or W1) is pressed by a crossover wire. Thus, the output wire of the V or W phase (V1 or W1) does not become loose from the winding start portion. By contrast, as shown in FIG. 5B, there is no crossover wire which presses the output wire of the U phase (U1). Thus, even though the output wire of the U phase (U1) is soldered to a board, winding may become loose (occurrence of loose wire).

A 3-phase brushless motor has core arm portions (slots between core arm portions) in a number of a multiple of 3. Three wires (U1, V1, and W1) called output wires must be bonded to a board or the like. In this case, in order to prevent loosening of wire, a wire which includes a winding start portion of each phase is usually made to serve as an output wire. Nevertheless, there arises a single region (boundary between three output wires and three common wires) where a crossover wire is absent. In the above-described embodiment, winding starts from W1, and a single wire is continuously wound to form windings. Even when winding starts from other than W1, a single output wire which cannot be pressed by a crossover wire is inevitably present. A conceivable means to press this single output wire in a manner equivalent to use of a crossover wire is hooking on a core arm portion of an adjacent phase; i.e., formation of an unnecessary coil on the core arm portion of the adjacent phase. However, this means that wire is wound several turns in a region which is not supposed to have a coil. Thus, inductance is formed in a region in which inductance does not add to performance of a motor, so that the motor fails to sufficiently exhibit magnetic characteristics thereof.

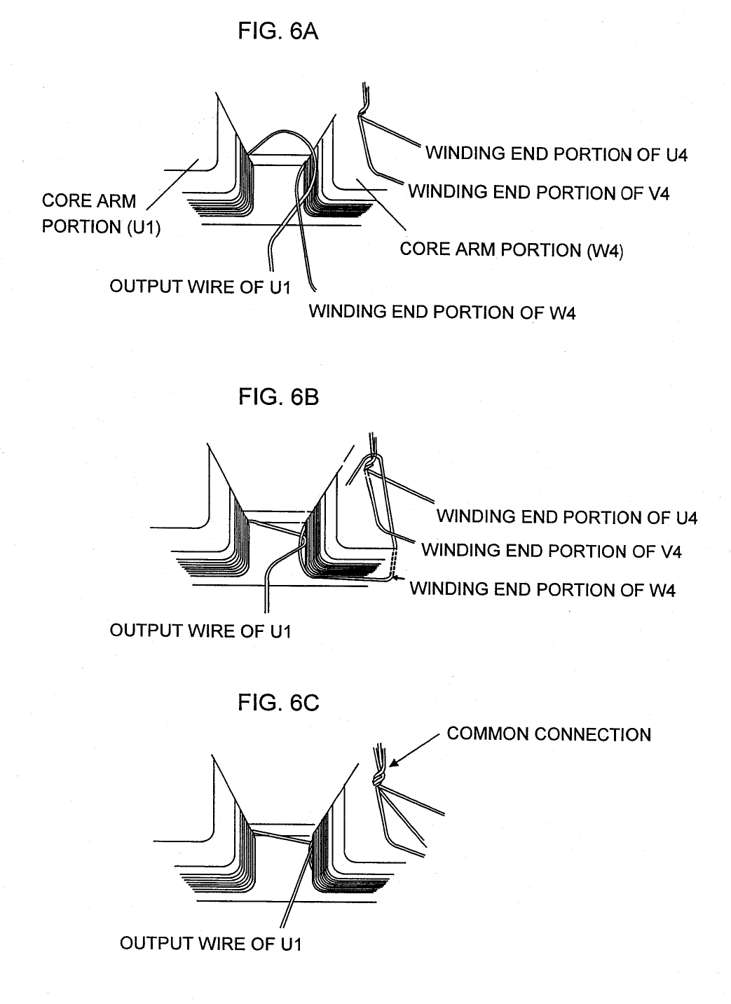

FIGS. 6A to 6C are views for explaining prevention of loosening of an output wire. The following description assumes that a single output wire which cannot be pressed by a crossover wire is of U1. As described with reference to FIG. 4, after completion of winding, the wire extending from W4 to V1 and the wire extending from V4 to U1 are cut away, and the resultant winding end portions of W4 and V4 and a winding end portion of U4 are connected together. FIG. 6A shows a state in which, after completion of winding, wires extending between phases are cut away, and a winding end portion of W4 is about to be twined around a winding end portion of U4 and a winding end portion of V4 so as to form a common connection. In this state, the output wire of U1 is threaded under a winding end portion of W4.

Next, as shown in FIG. 6B, the winding end portion of W4 is twined around the winding end portion of U4 and the winding end portion of V4. Then, as shown in FIG. 6C, the winding end portions of U4, V4, W4 are soldered together for common connection, thereby forming a common connection of a 3-phase system. As a result, the output wire of U1 is fixedly pressed by the winding end portion (winding end) of W4 of the adjacent phase, whereby occurrence of a loose wire or an overlying wire as described with reference to FIG. 5B is effectively prevented.

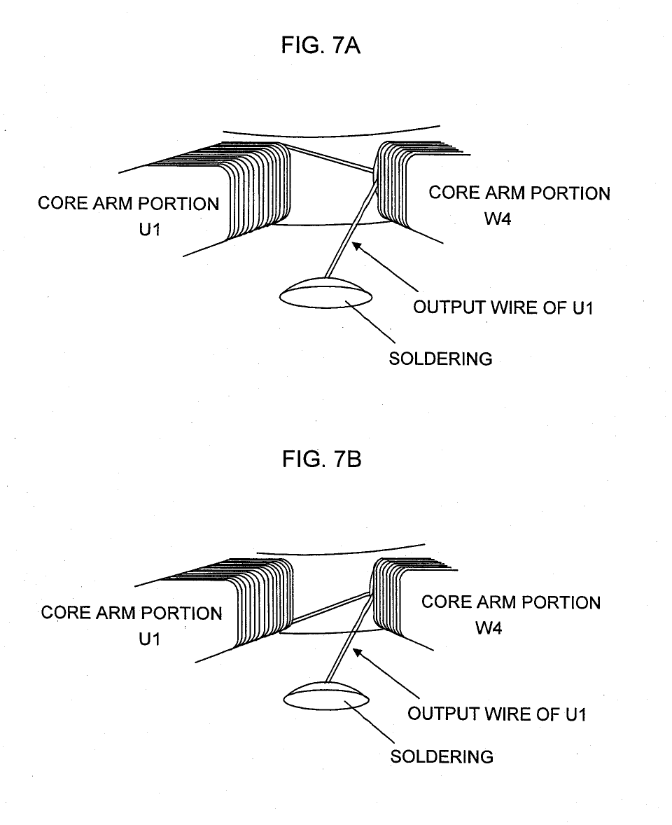

FIGS. 7A and 7B are views for explaining that an output wire is fixed independently of the direction of winding around a core arm portion. FIGS. 7A and 7B show the cases of opposite directions of winding around a core arm portion. In either case, the output wire can be fixed by a winding end portion of the adjacent phase.

What is claimed is:

1. A brushless motor in which winding is wound around each of a plurality of core arm portions formed integrally with a core cylinder portion of a stator core, comprising:
the windings wound around the respective core arm portions that are 3-phase-configured, one end of winding of each phase extending outwardly as an output wire, three output wires in total, and the other end of winding of each phase being connected at a common node, thereby establishing Y-connection; and
two of the three output wires being fixedly pressed by crossover wires extending between windings wound around the respective core arm portions, and the remaining one output wire being fixedly pressed by a winding end wire of winding of an adjacent phase.

2. A brushless motor according to claim 1, wherein a single wire is continuously wound to form all of the windings, and, after completion of winding, wires extending between phases are cut away.

3. A brushless motor according to claim 1, wherein the number of the core arm portions and the number of windings wound around the respective core arm portions are an integral multiple of 3.

4. A manufacturing method for a brushless motor in which winding is wound around each of a plurality of core arm portions formed integrally with a core cylinder portion of a stator core, the manufacturing method comprising:
forming windings around the respective core arm portions in a 3-phase-configuration such that one end of winding of each phase extends outwardly as an output wire, three output wires in total, and such that the other end of winding of each phase is connected at a common node, thereby establishing Y-connection; and
fixedly pressing two of the three output wires by crossover wires extending between windings wound around the respective core arm portions, and fixedly pressing the remaining one output wire by a winding end wire of winding of an adjacent phase.
